(19) United States
(12) Patent Application Publication
(10) Pub. No.: US 2007/0050205 A1
(43) Pub. Date: Mar. 1, 2007

(54) Healthcare payment system and method

(76) Inventor: Daniel M. Lieberman, Phoenix, AZ (US)

Correspondence Address: WEISS & MOY PC, 4204 NORTH BROWN AVENUE, SCOTTSDALE, AZ, 85251, US

(21) Appl. No.: 11/215,656

(22) Filed: Aug. 30, 2005

(51) Int. Cl. G06Q 10/00; G06Q 40/00

(52) U.S. Cl. 705/2; 705/35

(57) ABSTRACT

A system and method for payment of health care costs. A bank holds a plurality of health savings accounts. Proceeds from the accounts may be used to pay for medical services provided by health care providers, with whom the bank has negotiated service rates. Coding information relating to the services provided, and for which payment is made from the health savings account, may be transmitted from the health care provider to the bank.

### FIELD OF THE INVENTION

The present invention relates to health care payment systems and methods.

### BACKGROUND OF THE INVENTION

Health care costs and spending continue to rise in the U.S. In 2004, health spending by privately insured Americans increased by 8.2 percent. For that same year, medical costs grew nearly four times faster than the growth of wages. According to the most recent data from the U.S. Census Bureau, 45 million people (representing approximately 15% of the population) were uninsured in 2003.

The increasing cost of health care in the United States in particular creates problems for all participants in the system. For individuals with insurance, the rising cost of health care is expressed in the form of higher insurance premiums, deductibles, and co-pays. For those who lack insurance, the rise in health care costs is experienced directly.

From the point of view of the health care provider, there is generally a need to deal with multiple insurers, each having different rate structures and paperwork requirements. It is not uncommon for a health care provider to spend 30% or so of its overhead on insurance-related administration.

Pursuant to recent Medicare legislation, the U.S. government has decided to permit Health Savings Accounts (“HSA's”), which will hold pre-tax dollars that may be used by an individual in a high deductible health plan to pay certain non-covered expenses, such as deductibles and co-pays. Under the legislation, banks, credit unions, insurance companies, and certain others may serve as an HSA trustee or custodian. HSA's, as currently structured, are not intended to be used as a substitute for insurance and, indeed, are only available to persons who are covered by a high deductible health plan. In addition, the record-keeping burden with respect to payments from the account rests with the individual, who must be prepared to show, if audited, that disbursements from the account were proper.

There is a continuing need for systems and methods that may further contribute to a lowering of the cost of health care to the patient and/or the cost of insurance compliance to the health care provider, and further that may provide a basis for assisting uninsured individuals to pay health care costs. The present invention satisfies these needs and providers other, related, advantages.

### SUMMARY OF THE INVENTION

In accordance with an embodiment of the present invention, a health care payment system is disclosed. The system comprises, in combination: a bank; at least one health savings account held by the bank; at least one contractual relationship between the bank and at least one health care provider; wherein the contractual relationship governs rates to be paid from the health savings account to the health care provider for medical services; means for providing payment from the savings account to the health care provider for the medical services; and means for transmitting to the bank coding information relating to the medical services.

In accordance with another embodiment of the present invention, a method for paying health care costs is disclosed. The method comprises: facilitating the establishment of at least one health savings account in a bank; facilitating the formation of at least one contractual relationship between the bank and at least one health care provider; wherein the contractual relationship governs rates to be paid from the health savings account to the health care provider for medical services; providing means for providing payment from the savings account to the health care provider for the medical services; providing means for transmitting to the bank coding information relating to the medical services; facilitating payment from the savings account to the health care provider for the medical services; and facilitating transmission to the bank of coding information relating to the medical services.

### BRIEF DESCRIPTION OF THE DRAWINGS

FIG. 1 is a block diagram illustrating a health care payment system consistent with an embodiment of the present invention.

### DETAILED DESCRIPTION OF THE PREFERRED EMBODIMENTS

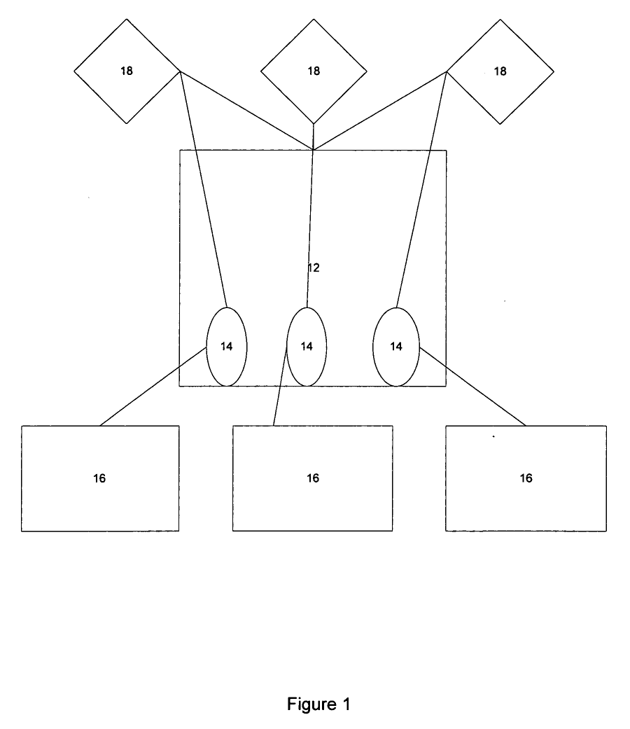

Referring to FIG. 1, the main actors in the system 10 of the present invention are illustrated. Health savings bank 12 (“bank 12”) holds a plurality of health savings accounts 14, belonging to patients 16. The bank 12 may also have contractual relationships with health care providers 18 (“providers 18”). Where such contractual relationships exist, they may include the negotiation of rates between the bank 12 and providers 18 for the provision of certain medical services for the benefit of patients 16. (It should be noted that rates could, for example, be unilaterally set by one or more providers 18, with no negotiation between the bank 12 and provider 18.)

The term “bank” is used herein to denote the trustee or custodian of an account as herein described. It may be a bank, other financial institution, insurance company, or other entity authorized by law to maintain an account as herein described. It should be noted that there may be more than one bank 12 which maintains patient accounts 14 in a system and method consistent with the present invention. As herein described, the term “bank” is encompassing both an entity that maintains patient accounts 14, and that may have contractual relationships with providers 18. It should be noted that more than one entity may perform the role of “bank” as herein described, with, for example, one entity holding patient accounts 14 and a second, network type of entity contracting with providers 18.

The bank 12 may operate a web-site or other publication having a database containing information concerning the identity of providers 18 with whom it has entered into reimbursement agreements. The database may include, in addition to the identity of the providers 18, information concerning the rates charged by providers 18—whether negotiated by the bank 12 or unilaterally set by providers 18. The rates that are published may relate to particular services performed by the providers 18, which services may be identified by reference to a suitable coding system, such as the CPT. For example, No. 99067, under the CPT system, is the code for a new patient visit. It is anticipated that publication of rate information may lead providers 18 to adjust their rates to be competitive and to drive business.

The term “service” as used herein is intended to encompass health care-related services, tests or other lab work, and health-related equipment. For example, it would include any of the following: physician services, laboratory services, surgical services, imaging, durable medical goods, medical equipment, orthotics, pathology services, etc. At a minimum, the term “service” should include anything purchasable with the proceeds of an HSA, at least as currently defined.

Patients 16 may be provided with access to the web-site, so that upon accessing the database, patients 16 may select a suitable provider 18. (To obtain access, it may be necessary for a patient 16 to input suitable identifying information, such as a username and password.) In making the selection of a provider 18, the patient 16 may take into consideration any published rate information concerning the provider 18. In addition, the publication of such price information may contribute to price competition between providers 18- to the benefit of patients 16. It should be noted that the database of information herein described need not be published on a web-site or the like, and may be published, for example, in a hard-copy directory or any other desired format.

The bank 12 may issue to the patient 16 a debit card, check book, or the like, the value of which may be coupled to the amount of funds contained within the particular patient 16's account 14. In order to pay for services from a provider 18, it is contemplated that the patient 16 may provide the provider 18 with the debit card, check, or other payment means, to facilitate the debiting of the account 14 by the amount agreed between the provider 18 and the bank 12 for a particular service. Where a debit card or the like is used, it may be provided that, upon being charged, the code number for the particular service performed may be recorded and transmitted to the bank 12. In this manner, in a single, paperless, transaction, payment is made from the bank 12 to the provider 18, and coding information is transmitted from the provider 18 to the bank 12.

The bank 12 may desire to charge a fee to the patient 16 for maintenance of the savings account 14. For example, the bank 12 may elect to charge a per-transaction fee, whether in a fixed amount or in the form of a percentage of the amount of the transaction. Additionally and/or in the alternative, the bank 12 may charge a fee to the provider 18, including for example a percentage (e.g., 5%) of the transaction; a fixed, per-transaction fee; or some other form of consideration.

It may additionally be desired for the bank 12 to make available to patients 16 loans for the payment of medical expenses that are beyond the capacity of the account 14. It may be contemplated that, at least in part, such loan would be repaid using contents of the account 14 in future years. Such loans may be secured by, for example, assets belonging to the patient 16. The ability to obtain such loans may provide a measure of protection against the cost associated with a catastrophic injury.

The web-site as herein described may contain information in addition to that described above. For example, it may contain consumer opinion/feedback regarding the service provided, including regarding the physician, laboratory, hospital or other actor providing such service. It may additionally include performance measurements regarding the practice or other entity providing the service, such as average waiting time, consumer/patient satisfaction, duration of visit, and the like. The web-site may additionally facilitate calculation and display of the anticipated charge for a service selected by the consumer/patient.

I claim:

1. A health care payment system comprising, in combination:
a bank;
at least one health savings account held by the bank;
means for providing payment from the savings account to the health care provider for the medical services; and
means for transmitting to the bank coding information relating to the medical services.

2. The health care payment system of claim 1 wherein the payment means comprises a debit card.

3. The health care payment system of claim 1 further comprising a database identifying the health care provider, and wherein the database is available to be inspected by a holder of the health savings account.

4. The health care payment system of claim 3 wherein the database further contains information regarding the rates to be paid from the health savings account to the health care provider for the medical services.

5. The health care payment system of claim 1 further comprising means for extending a loan from the bank to a holder of the health savings account for medical expenses in excess of the health savings account.

6. The health care payment system of claim 1 wherein the contractual relationship governs rates to be paid from the health savings account to the health care provider for medical services.

7. A method for paying health care costs comprising:
facilitating the establishment of at least one health savings account in a bank;
providing means for providing payment from the savings account to the health care provider for the medical services;
providing means for transmitting to the bank coding information relating to the medical services;
facilitating payment from the savings account to the health care provider for the medical services; and
facilitating transmission to the bank of coding information relating to the medical services.

8. The method of claim 7 wherein the payment means comprises a debit card.

9. The method of claim 7 further comprising providing a database identifying the health care provider, and wherein the database is available to be inspected by a holder of the health savings account.

10. The method of claim 7 wherein the database further contains information regarding the rates to be paid from the health savings account to the health care provider for the medical services.

11. The method of claim 7 further comprising providing means for extending a loan from the bank to a holder of the health savings account for medical expenses in excess of the health savings account.

12. The method of claim 7 further comprising facilitating payment from the health savings account to the bank in consideration for services provided by the bank to a holder of the health savings account.

13. The method of claim 12 further comprising facilitating payment from the health care provider to the bank in consideration for services provided by the bank to the health care provider.

14. The method of claim 7 wherein the contractual relationship governs rates to be paid from the health savings account to the health care provider for medical services.

15. The method of claim 10 wherein the database contains opinion information regarding at least one of the provider and the medical service.

16. The method of claim 10 wherein the database contains performance measurements regarding the provider.
